(19) United States
(12) Patent Application Publication
(10) Pub. No.: US 2007/0117589 A1
(43) Pub. Date: May 24, 2007

(54) Wireless communication system

(76) Inventors: Tomonori Sugiyama, Shizuoka-shi (JP); Naohiro Matsushita, Mishima-shi (JP); Masakazu Kato, Numazu-shi (JP); Sadatoshi Oishi, Fuji-shi (JP); Jun Yaginuma, Izunokuni-shi (JP); Kenichiro Watanabe, Saitama-shi (JP); Kenjiro Aizawa, Inba-gun (JP); Hiroyuki Nakatsukasa, Nagoya-shi (JP)

Correspondence Address: HARNESS, DICKEY & PIERCE, P.L.C., P.O. BOX 828, BLOOMFIELD HILLS, MI, 48303, US

(21) Appl. No.: 11/595,800

(22) Filed: Nov. 10, 2006

(30) Foreign Application Priority Data
Nov. 14, 2005 (JP) 2005-328716

(51) Int. Cl. H04B 1/38; H04M 1/00

(52) U.S. Cl. 455/561

(57) ABSTRACT

A wireless base station uses a leaky transmission line as an antenna, and a wireless base station uses a leaky transmission line as an antenna. The leaky transmission line and the leaky transmission line are laid parallel to each other. An interval between the leakage transmission paths is set to a distance at which it is impossible for the wireless base stations to sense each other's carrier while using a same wireless channel, and to be not more than twice as long as a maximum distance between leaky transmission lines, and wireless communication terminals at which it is possible for wireless base stations to respectively establish wireless links to wireless communication terminals.

### CROSS-REFERENCE TO RELATED APPLICATIONS

This application is based upon and claims the benefit of priority from prior Japanese Patent Application No. 2005-328716, filed Nov. 14, 2005, the entire contents of which are incorporated herein by reference.

### BACKGROUND OF THE INVENTION

1. Field of the Invention

The present invention relates to a wireless communication system in which a plurality of wireless base stations using leaky transmission lines as antennas are set up, and in the wireless communication system, the wireless base stations respectively communicate with corresponding wireless communication terminals via the leaky transmission lines.

2. Description of the Related Art

For example, Jpn. Pat. Appln. KOKAI Publication No. 7-193857 discloses a system in which a plurality of base stations are set up in a service area for wireless communication, and six sector antennas with horizontal radiation pattern of a half-value angle of 60° are respectively connected to the base stations. In this system, the sector antennas of the base stations cover sector cells equally dividing the circumference of each base station into six so as to correspond to the horizontal radiation pattern.

Because the system described in this publication can communicate with a wireless communication terminal for each sector cell by switching the sector antennas in a time-division system, even in an environment in which wireless communication terminals are dense.

In the system described in the publication, however, the control of the antennas of the base stations is complicated, and a communication speed is slowed down because of the time-shared control. Moreover, when an adjacent base station uses a same channel, it is impossible for the base stations to communicate with wireless communication terminals within sector cells close to the adjacent base stations.

### BRIEF SUMMARY OF THE INVENTION

An object of the present invention is to provide a wireless communication system in which a plurality of wireless base stations using leaky transmission lines as antennas are set up, and the wireless base stations respectively communicate with corresponding wireless communication terminals via the leaky transmission lines. In the wireless communication system, the leaky transmission lines connected with base stations are set up parallel to one another.

When the wireless base stations connected to the respective leaky transmission lines communicate with corresponding wireless communication terminals by using a same wireless channel, An interval between two adjacent leaky transmission lines are laid to a distance at which the wireless base stations cannot sense carrier. Besides, The interval is set to twice the maximum distance that the wireless base station connected to the respective leaky transmission path can establish a wireless link to a corresponding wireless communication terminal.

In the wireless communication system of the invention, a plurality of wireless base stations can be set up in high density, which makes it possible to efficiently communicate with many wireless communication terminals. Further, radio base stations in neighborhood can use the same channel repeatedly. Moreover, it is possible to reduce leakage of radio wave to the exterior as much as possible.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a wireless communication system according to a first embodiment of the present invention;

FIG. 2 is a diagram showing an example deciding a maximum distance L that a wireless base station can establish a wireless link to a wireless communication terminal in the first embodiment;

FIG. 3 is a diagram showing an example deciding a minimum distance that two adjacent wireless base stations cannot sense carrier each other in the first embodiment.

FIG. 4 is a view showing an example of throughput measurement when the wireless communication terminals communicate with servers connected to the wireless base stations in the first embodiment;

FIG. 5 is a view showing a wireless communication system according to a second embodiment of the present invention;

FIG. 6 is a view showing a wireless communication system according to a third embodiment of the present invention;

FIG. 7 is a partially sectional view showing one example of layout of a leaky transmission line in the third embodiment;

FIG. 8 is a partially sectional view showing another example of the layout of the leaky transmission line in the third embodiment;

FIG. 9 is a view showing a wireless communication system according to a fourth embodiment of the present invention;

FIG. 10 is a perspective view showing one example of layout of a leaky transmission line in the fourth embodiment;

FIG. 11 is a perspective view showing another example of the layout of the leaky transmission line in the fourth embodiment;

FIG. 12 is a partially sectional view showing the another example of the layout of the leaky transmission line in the fourth embodiment, which is taken along the layout direction;

FIG. 13 is a partially sectional view showing the example of FIG. 12, which is taken along a direction perpendicular to the layout direction of the leaky transmission line;

FIG. 14 is a view showing another example of layout of desks in the fourth embodiment;

FIG. 15 is a diagram showing yet another example of layout of desks in the fourth embodiment;

FIG. 16 is a partially sectional view showing another example of layout of the leaky transmission line in the layout of the desks in FIGS. 14 and 15, which is taken along-the layout direction;

FIG. 17 is a partially sectional view showing the example of the FIG. 16, which is taken along a direction perpendicular to the layout direction of the leaky transmission line;

FIG. 18 is a partially sectional view showing another example of layout of the leaky transmission line in the layout of the desks in FIGS. 14 and 15, which is taken along the layout direction; and

FIG. 19 is a partially sectional view showing the example of the FIG. 18, which is taken along a direction perpendicular to the layout direction of the leaky transmission line.

### DETAILED DESCRIPTION OF THE INVENTION

### FIRST EMBODIMENT

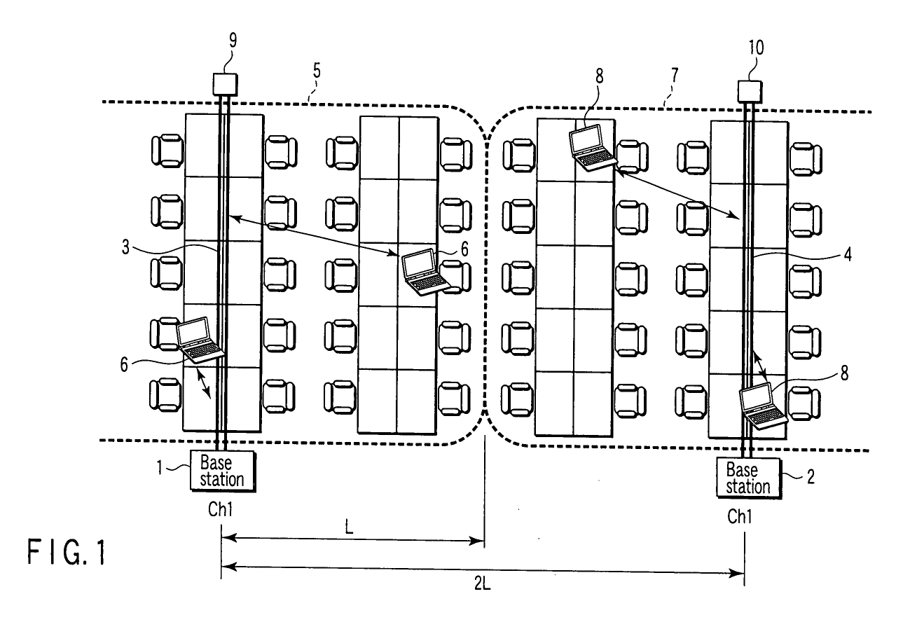

FIG. 1 shows a configuration of a wireless communication system. In the wireless communication system, two wireless base stations 1 and 2 using the same wireless channel CH1 are set up the same floor. Leaky transmission lines 3 and 4 are connected to the wireless base stations 1 and 2, respectively.

Wireless base station 1 communicates with a wireless communication terminal 6 within a communication service area 5 via leaky transmission line 3. Wireless base station 2 communicates with a wireless communication terminal 8 within a communication service area 7 via leaky transmission line 4.

Terminators 9 and 10 are connected to the ends of the leaky transmission lines 3 and 4, respectively. The leaky transmission lines 3 and 4 are laid linearly and parallel to each other.

Communication service area 5 formed by wireless base station 1 and leaky transmission line 3 is bounded on communication service area 7 formed by wireless base station 2 and leaky transmission line 4. The boundary between the communication service areas is a distance L away from leaky transmission line 3, and a distance L away from leaky transmission line 4. Accordingly, the distance between the leaky transmission lines 3 and 4 is 2L.

Distance L is the maximum distance that the wireless base stations 1 and 2 can establish wireless links to the wireless communication terminals 6 and 8. Further, distance 2L is a distance that the wireless base stations 1 and 2 which use the same channel cannot sense each other's carrier.

Note that, in the wireless communication system, the distance between the leaky transmission lines 3 and 4 is not limited to 2L. Distance 2L is the upper limit to set up wireless base stations efficiently and at high density. When the distance between the leaky transmission lines 3 and 4 is laid longer than 2L, dead area in which it is impossible to establish wireless links from both of the wireless base stations 1 and 2 is generated between the service areas 5 and 7, which makes it impossible to efficiently set up the wireless base stations.

When the distance between the leaky transmission lines 3 and 4 becomes the distance at which the wireless base stations 1 and 2 can sense each other's carrier, the wireless base stations 1 and 2 cannot use the wireless channel CH1 when one of those uses the wireless channel CH1.

Accordingly, a lower limit of distance between the leaky transmission lines 3 and 4 gradually separates each other, and it is the distance at which the wireless base stations 1 and 2 cannot sense each other's carrier.

Therefore, the leaky transmission lines 3 and 4 are laid in the distance at which the wireless base stations 1 and 2 cannot sense each other's carrier. By laying the leaky transmission lines 3 and 4 at such a distance, the wireless base stations 1 and 2 can be efficiently set up at high density, and can simultaneously use the same wireless channel CH1.

As a consequence, the wireless base stations 1 and 2 can efficiently communicate with many wireless communication terminals, and can repeatedly use the same wireless channel. Moreover, because the leaky transmission lines 3 and 4 are used as antennas, it is possible for the wireless communication system to reduce external leakage of radio waves as much as possible.

The following example describes an example of deciding a maximum distance L that a wireless base station 1 (or 2) can establish a wireless link to a wireless communication terminal 6 (or 8), and minimum distance that two adjacent wireless base stations 1 and 2 cannot sense carrier each other.

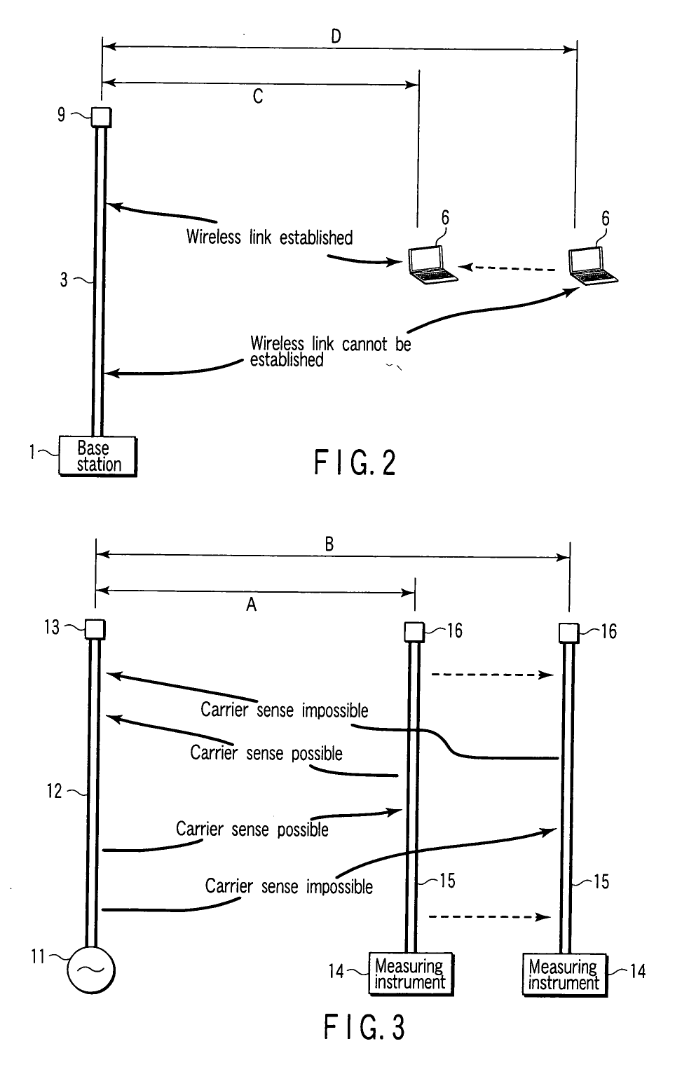

FIG. 2 shows an example deciding a maximum distance L that a wireless base station 1 can establish a wireless link to a wireless communication terminal 6.

First, wireless communication terminal 6 put the place D that the wireless communication terminal 6 cannot establish a wireless link to wireless base station 1.

Then, while wireless communication terminal 6 is approximating to leaky transmission line 3 as shown by the dotted-line arrow, wireless communication terminal 6 tries to establish a wireless link to wireless base station 1.

Then, when a wireless link is established, a distance C at that time between leaky transmission line 3 and wireless communication terminal 6 is the maximum distance L that a wireless base station 1 can establish a wireless link to a wireless communication terminal 6.

FIG. 3 shows one example deciding a minimum distance that the wireless base stations cannot sense each other's carrier.

A signal generator 11 is used in place of a wireless base station. Leaky transmission line 12 is connected to the signal generator 11. Then, an end of leaky transmission line 12 is connected to a terminator 13.

Further, a measuring instrument 14, such as a spectrum analyzer, which measures received field intensity is used. A leaky transmission line 15 is connected to the measuring instrument 14. Then, an end of leaky transmission line 15 is connected to a terminator 16. The leaky transmission lines 12 and 15 are laid linearly and parallel to each other.

The signal generator 11 is operated in a state that the distance between the leaky transmission lines 12 and 15 is short. A radio wave is radiated externally from leaky transmission line 12 by the operation of the signal generator 11. Then, the radio wave radiated from leaky transmission line 12 is received at leaky transmission line 15, and the measuring instrument 14 measures the received field intensity.

The received field intensity measured by the measuring instrument 14 is higher than a carrier sense threshold level set in advance, because a distance between the leaky transmission lines 12 and 15 is short. Accordingly, the distance A is a distance at which the wireless base stations can sense each other's carrier.

From this state, as shown by the dotted-line arrows in the drawing, the leaky transmission line 15 is gradually separated from the leaky transmission line 12 in parallel with the leaky transmission line 12. Then, every time the leaky transmission line 15 is separated a little, the measuring instrument 14 measures the received filed intensity.

When the received filed intensity measured by the measuring instrument 14 is lower than the carrier sense threshold level, a distance B at that time between the leaky transmission line 12 and the leaky transmission line 15 is a minimum distance at which the wireless base stations cannot sense each other's carrier.

An experiment result in an office will be described as the following example.

Leaky coaxial cables with a coupling loss of 65 dB, a transmission loss of 0.25 dB/m, and a length is 10 m are used as leaky transmission lines.

As radio wave, a 2.4 GHz band is used. Communication at that time is conformed to the standard of IEEE802.11g (the specification for a wireless LAN at 2.4 GHz band devised by the IEEE8.2.11 working group).

Note that there are 1, 2, 5.5, 6, 9, 11, 12, 18, 24, 36, 48, and 54 Mbps as a wireless link speed according to IEEE802.11g.

An experiment is carried out for deciding a distance L between the wireless communication terminal 6 and the leaky coaxial cable 3 when a wireless base station 1 can establish a wireless link to a wireless communication terminal 6 at 1 Mbps which is a minimum wireless link speed. In this experiment, first, the wireless communication terminal 6 is separated at about 40 m from the leaky coaxial cable 3, and it is confirmed that a wireless base station 1 cannot establish a wireless link to a wireless communication terminal 6.

Subsequently, the wireless communication terminal 6 approximates to the leaky coaxial cable to establish a wireless link of the wireless base station 1 and the wireless communication terminal. Then, it is confirmed that the wireless communication terminal 6 has established a wireless link to the wireless base station 1 at a distance of about 25 m from the leaky coaxial cable.

Next, an experiment for deciding a distance at which wireless base stations cannot sense each other's carrier. In this experiment, the leaky coaxial cable to which the signal generator 11 is connected and the leaky coaxial cable to which the measuring instrument 14 is connected are laid parallel to each other at a predetermined distance. Then, received field intensity is measured by the measuring instrument 14. The received field intensity at this time is higher than the carrier sense threshold level.

Subsequently, an interval between the two leaky coaxial cables is separated a little, and received field intensity is measured by the measuring instrument 14. In this way, every time an interval between the two leaky coaxial cables is separated a little, the measuring instrument 14 measures the received filed intensity. Then, a place where the measured received field intensity is lower than the carrier sense threshold level (the carrier sense threshold level of IEEE 802.11g is −76 dBm) is found. In this experiment, when two leaky coaxial cables were 5 m, the received field intensity is lower than carrier sense threshold level.

Accordingly, in an environment of this experiment, an interval between the leaky coaxial cables respectively connected to the two wireless base stations using the same wireless channel must be more than 5 m at which the wireless base stations cannot sense each other's carrier. Further, this must be not more than twice as long as the maximum distance L=25 m between the wireless communication terminal and the leaky coaxial cable at which it is possible for the wireless communication terminal and the leaky coaxial cable to establish a wireless link to each other.

Consequently, provided that the leaky coaxial cables are laid such that an interval between the leaky coaxial cables respectively connected to the wireless base stations is within a range from 5 m to 50 m, it is possible for the wireless base stations to simultaneously communicate with corresponding wireless communication terminals by using a same channel.

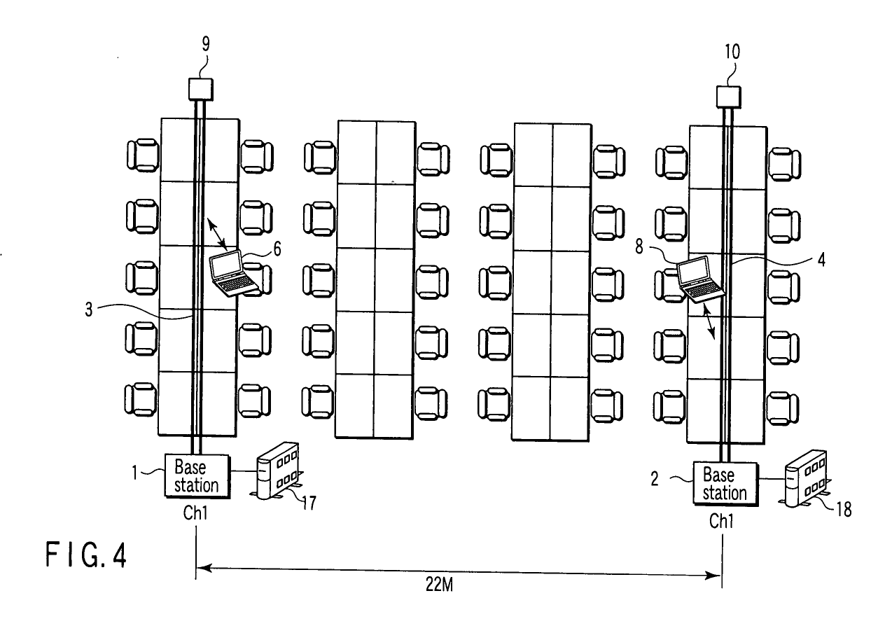

Next, as shown in FIG. 4, a server 17 is connected to the wireless base station 1 using the wireless channel CH1, and a server 18 is connected to the wireless base station 2 using the same wireless channel CH1. Then, the wireless communication terminal 6 communicates with the server 17 via the leaky coaxial cable 3 and the wireless base station 1, and the wireless communication terminal 8 communicates with the server 18 via the leaky coaxial cable 4 and the wireless base station 2. In this case, throughputs are as follows.

An interval between the leaky coaxial cables 3 and 4 is set to 22 m. Throughputs when the wireless communication terminal 6 has communicated with the server 17 via the leaky coaxial cable 3 and the wireless base station 1 have been 19.5 Mbps in uploading, and 19.3 Mbps in downloading.

Further, average of the throughputs when the two wireless communication terminals 6 and 8 have simultaneously communicated, namely, when the wireless communication terminal 6 has communicated with the server 17 via the leaky coaxial cable 3 and the wireless base station 1, and the wireless communication terminal 8 has communicated with the server 18 via the leaky coaxial cable 4 and the wireless base station 2, have been 13.8 Mbps in uploading, and 13.8 Mbps in downloading.

The two wireless base stations 1 and 2 are not communicated independently from each other because the same channel is used. However, because the both wireless base stations 1 and 2 are set up at positions at which it is impossible to sense each other's carrier, throughputs are not reduced to half of the throughputs when the one wireless communication terminal 6 is used, and throughputs are 70% or more.

On the other hand, average of throughputs of the two wireless communication terminals when the wireless base stations 1 and 2 are set up at positions at which it is possible to sense each other's carrier, and the wireless communication terminals 6 and 8 respectively communicate with the servers 17 and 18, have been 10.1 Mbps in uploading, and 9.5 Mbps in downloading. Namely, the throughputs in both the uploading and downloading have been reduced to about half of the throughputs in a case of one wireless communication terminal.

In this way, the result has been became in which throughputs when the leaky coaxial cables are laid at which it is impossible to sense each other's carrier are higher in both of uploading and downloading than those in the other case that the leaky coaxial cables are laid at which it is possible to sense each other's carrier.

As described above, with respect to the leaky transmission lines respectively connected to the two wireless base stations 1 and 2 using the same wireless channel, a distance between the leakage transmission which is twice as long as a maximum distance at which it is possible for the wireless communication terminals and the wireless base stations to establish wireless links at a desired wireless link speed is an upper limit. Further, the minimum distance at which the two wireless base stations 1 and 2 using the same wireless channel cannot sense each other's carrier is a lower. Then, by laying the two leaky transmission lines parallel to each other between the upper limit and the lower limit, the wireless base stations are set up in high density, which makes it possible for the wireless communication system to communicate with many wireless communication terminals.

Besides, the two wireless base stations 1 and 2 can use the same wireless channel repeatedly. Moreover, the leaky transmission lines are used as antennas. For this reason, it is possible to reduce leakage of radio wave to the exterior from the leaky transmission lines as much as possible.

Note that, when the layout of the leaky transmission lines is limited in advance, transmission electric power supplied to the leaky transmission lines may be adjusted after the leaky transmission lines are laid.

Transmission electric power adjusting means controls transmission electric power supplied to the leaky transmission lines. As such transmission electric power adjusting means is build in a wireless base station.

Alternatively, transmission electric power is adjusted by selecting a wireless base station to be used from among a plurality of wireless base stations with different transmission electric power. Or, transmission electric power is adjusted by inserting an attenuator between a wireless base station and a leaky transmission line. Or, transmission electric power is adjusted by inserting an amplifier between a wireless base station and a leaky transmission line.

For example, in a case of a situation in which desks have been already aligned on a floor as shown in FIG. 1, the leaky transmission lines 3 and 4 connected to the wireless base stations 1 and 2 using the same wireless channel CH1 are laid parallel to each other at the central portions between the rows of desks. Then, transmission electric power to be supplied to the leaky transmission line 3 is controlled less than transmission electric power at which the wireless base station 1 and the wireless base station 2 can sense each other's carrier, and not less than transmission electric power at which it is possible for the wireless base station 1 to establish a wireless link to the wireless communication terminal 6 at a distance not less than half of a distance between the two leaky transmission lines 3 and 4 laid parallel to each other.

In the same way, transmission electric power to be supplied to the leaky transmission line 4 is controlled to be less than transmission electric power at which the wireless base station 1 and the wireless base station 2 can sense each other's carrier, and to be not less than transmission electric power at which it is possible for the wireless base station 2 to establish a wireless link to the wireless communication terminal 8 at a distance not less than half of a distance between the two leaky transmission lines 3 and 4 laid parallel to each other.

Accordingly, wireless base station 1 does not sense the carrier of wireless base station 2, and establishes a wireless link to wireless communication terminal 6 in a border between two communication areas. Further, wireless base station 2 does not sense the carrier of wireless base station 1, and establishes a wireless link to wireless communication terminal 8 in a border between two communication areas.

In this way, the wireless base stations are set up in high density by controlling transmission electric power to be supplied to the leaky transmission lines, and as a consequence, it is possible for the wireless communication system to efficiently communicate with many wireless communication terminals.

In addition, the two wireless base stations 1 and 2 can use a same wireless channel repeatedly. Moreover, the leaky transmission lines are used as antennas. For this reason, it is possible to reduce leakage of radio wave from the leaky transmission lines to the exterior as much as possible.

### SECOND EMBODIMENT

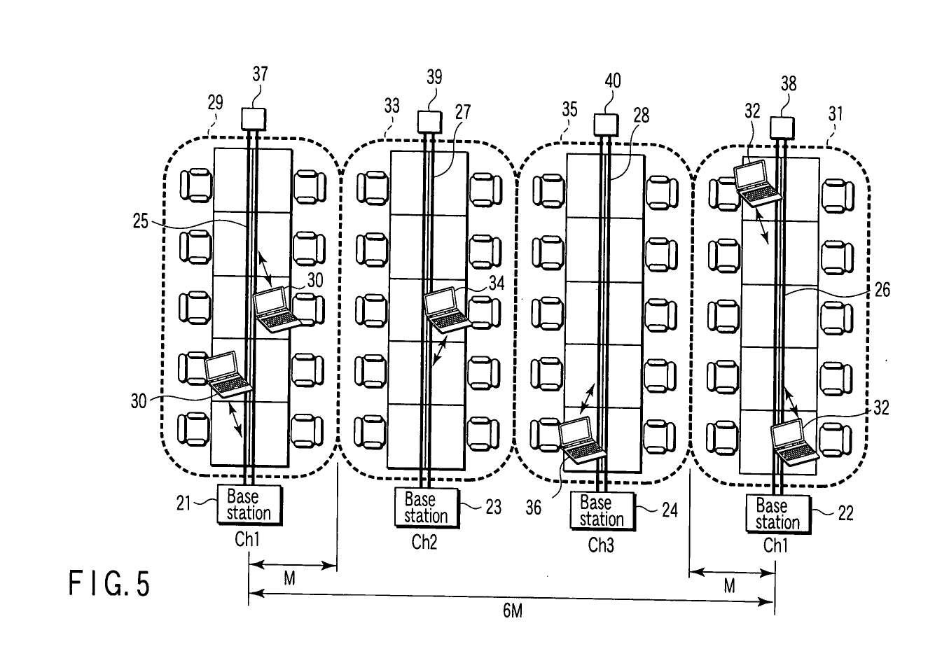

FIG. 5 shows a wireless communication system in which two wireless base stations 21 and 22, and two wireless base stations 23 and 24 are set up a same floor such that the wireless base stations 23 and 24 are located between the wireless base stations 21 and 22. The two wireless base stations 21 and 22 use the same wireless channel CH1. The two wireless base stations 23 and 24 use wireless channels CH2 and CH3.

In the wireless communication system, leaky transmission lines 25, 26, 27, and 28 are connected to the respective base stations 21, 22, 23, and 24.

The wireless base station 21 communicates with a wireless communication terminal 30 within a communication service area 29 via the leaky transmission line 25. The wireless base station 22 communicates with a wireless communication terminal 32 within a communication service area 31 via the leaky transmission line 26. The wireless base station 23 communicates with a wireless communication terminal 34 within a communication service area 33 via the leaky transmission line 27. The wireless base station 24 communicates with a wireless communication terminal 36 within a communication service area 35 via the leaky transmission line 28.

Note that, terminators 37, 38, 39, and 40 are connected to ends of the leaky transmission lines 25, 26, 27, and 28, respectively. The leaky transmission lines 25, 26, 27, and 28 are laid linearly and parallel to one another.

A range at the leaky transmission line 26 side of the communication service area 29 formed by the wireless base station 21 and the leaky transmission line 25 is up to a distance M from the leaky transmission line 25. Further, a range at the leaky transmission line 25 side of the communication service area 31 formed by the wireless base station 22 and the leaky transmission line 26 is up to a distance M from the leaky transmission line 26.

Further, a range of the communication service area 33 formed by the wireless base station 23 and the leaky transmission line 27 is up to a distance M from the leaky transmission line 27 to the both sides. Further, a range of the communication service area 35 formed by the wireless base station 24 and the leaky transmission line 28 is up to a distance M from the leaky transmission line 28 to the both sides.

The distance M is a maximum distance to the respective leaky transmission lines 25, 26, 27, and 28 when it is possible for the wireless communication terminals 30, 32, 34, and 36 to respectively establish wireless links to the wireless base stations 21, 22, 23, and 24.

The communication service areas 29, 33, 35, and 31 are bounded on each other, and therefore, a distance between the leaky transmission line 25 and the leaky transmission line 26 which use the same wireless channel CH1 is 6×M. The distance 6×M is a result in which maximum distances at which the respective wireless base stations 21, 22, 23, and 24 can establish wireless links to the wireless communication terminals 30, 32, 34, and 36 are summed up. The distance 6×M is a distance sufficiently longer than a distance at which it is possible for the wireless base stations 21 and 22 using the same channel to sense each other's carrier.

Note that, in the wireless communication system, a distance between the leaky transmission line 25 and the leaky transmission line 26 is not limited to 6×M. The distance 6×M is the upper limit to set up the wireless base stations efficiently and in high density. Namely, when a distance between the leaky transmission line 25 and the leaky transmission line 26 is laid longer than 6×M, a dead area in which it is impossible to establish a wireless link is generated between the service areas 29 and 33, the service areas 33 and 35, or the service areas 35 and 31, which makes it impossible to efficiently set up the wireless base stations.

Further, because the wireless channels to be used are different from one another, it is possible to bring the leaky transmission line 25 close to the leaky transmission line 27, or to bring the leaky transmission line 27 close to the leaky transmission line 28, or to bring the leaky transmission line 26 close to the leaky transmission line 28. Accordingly, it is possible to bring the leaky transmission line 25 and the leaky transmission line 26 close than 6×M.

Assume that a distance between the leaky transmission line 25 and the leaky transmission line 26 becomes a distance at which it is possible for wireless base stations 21 and 22 to sense each other's carrier. In this case, if one of those uses the wireless channel CH1, the other one cannot use the wireless channel CH1. Namely, wireless base stations 21 and 22 cannot use the same wireless channel simultaneously.

Accordingly, a lower limit of distance between the leaky transmission line 25 and the leaky transmission line 26 gradually separates each other, and it is the distance at which the wireless base stations 21 and 22 cannot sense each other's carrier.

In practice, with respect to a desired wireless link speed to be used for communication, a distance which is six times as long as a maximum distance M at which it is possible for a wireless communication terminal and a wireless base station to establish a wireless link to one another at the wireless link speed is an upper limit as an interval between the leaky transmission lines 25 and 26 respectively connected to the wireless base stations 21 and 22 using the same wireless channel. Further, a minimum distance at which the two wireless base stations 21 and 22 cannot sense each other's carrier is a lower limit. The four leaky transmission lines 25, 26, 27, and 28 are laid parallel to one another at predetermined intervals within a range between the upper limit and the lower limit.

In this way, a distance between the leaky transmission line 25 and the leaky transmission line 26 is laid to a distance at which wireless base stations 21 and 22 cannot sense each other's carrier, and to a distance 6 M or less. Thereby, the respective wireless base stations 21, 22, 23, and 24 can be efficiently set up at high density. In addition, wireless base stations 21 and 22 can use the same wireless channel CH1 simultaneously.

As a consequence, it is possible for the wireless communication system to efficiently communicate with many wireless communication terminals. Further, the wireless base station 21 and the wireless base station 22 can repeatedly use the same wireless channel. Moreover, because the wireless communication system uses the leaky transmission lines 25 to 28 as antennas, it is possible to reduce leakage of radio wave to the exterior as much as possible.

Note that, when 5 GHz band is used as a radio wave, communication is conformed to the standard of IEEE802.11g (the specification for high-speed wireless LAN access at 5 GHz band devised by the IEEE8.2.11 working group). There are 6, 9, 12, 18, 24, 36, 48, and 54 Mbps as a wireless link speed.

When there is a desired wireless link speed, two adjacent leaky transmission lines are laid parallel to each other at an interval satisfying the following two conditions. One of the conditions is to set a distance at which two wireless base stations respectively connected to the two leaky transmission lines use the same wireless channel cannot sense carrier each other. The other one of the conditions is to set a distance not more than twice as long as the maximum distance between the leaky transmission line and the wireless communication terminal at which the wireless communication terminal and the base station can be connected at a desired wireless link speed.

Note that, when the layout of the leaky transmission lines is limited, transmission electric power supplied to the leaky transmission lines may be adjusted after the leaky transmission lines are laid. Then, by this adjustment, the distance between the two leaky transmission lines is satisfied the two conditions described above.

Transmission electric power supplied to the leaky transmission lines is controlled by transmission electric power adjusting means. As such transmission electric power adjusting means is build in a wireless base station. Alternatively, transmission electric power is adjusted by selecting a wireless base station to be used from among a plurality of wireless base stations with different transmission electric power. Or, transmission electric power is adjusted by inserting an attenuator between a wireless base station and a leaky transmission line. Or, transmission electric power is adjusted by inserting an amplifier between a wireless base station and a leaky transmission line.

For example, in a case of a situation in which desks have been already aligned on a floor as shown in FIG. 5, the leaky transmission lines 25 and 26 connected to the wireless base stations 21 and 22 using the same wireless channel CH1 are laid parallel to each other at the central portions between the rows of desks. The two leaky transmission lines 27 and 28 connected to the wireless base stations 23 and 24 which use wireless channels different from the wireless channel used by the two wireless base stations 21 and 22 and different from each other are laid between the leaky transmission lines 25 and 26.

Note that the leaky transmission lines laid between the leaky transmission lines 25 and 26 are not limited to two, and may be three or more.

In the case of FIG. 5, transmission electric power supplied to the leaky transmission line 25 is controlled less than transmission electric power at which wireless base stations 21 and 22 can sense each other's carrier, and not less than transmission electric power at which it is possible for the wireless base station 21 to establish a wireless link to the wireless communication terminal 30 at a distance not less than half of a distance between the two adjacent leaky transmission lines 25 and 27 laid parallel to each other.

In the same way, transmission electric power supplied to the leaky transmission line 26 is controlled less than electric power at which wireless base stations 21 and 22 can sense each other's carrier, not less than transmission electric power at which it is possible for the wireless base station 22 to establish a wireless link to the wireless communication terminal 32 at a distance not less than half of a distance between the two adjacent leaky transmission lines 26 and 28 laid parallel to each other.

### THIRD EMBODIMENT

A layout for leaky transmission lines will be described as a third embodiment of the invention. The layout can be applied to the respective embodiments described above.

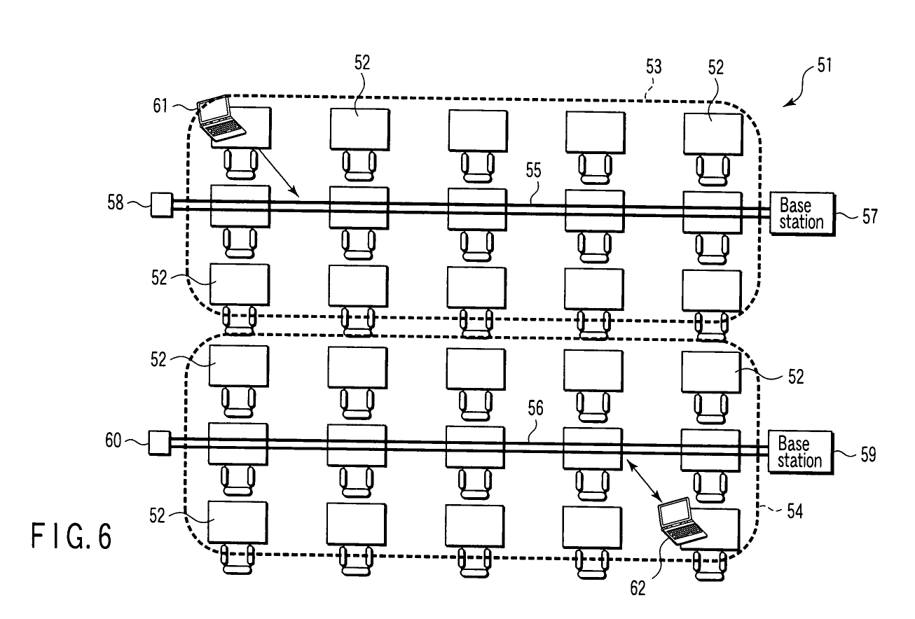

As shown in FIG. 6, desks 52 are arranged in five rows horizontally and in six rows vertically on the floor 51 in the office. In such layout, wireless communication segments are separated into a first wireless communication segment 53 which are in five rows horizontally and in three rows vertically, which are the upper half, and a second wireless communication segment 54 in five rows horizontally and in three rows vertically, which are the lower half.

Then, in order for these two wireless communication segments 53 and 54 to be different wireless communication areas, a first leaky transmission line 55 is laid at the central portion of the wireless communication segment 53, and a second leaky transmission line 56 is laid at the central portion of the wireless communication segment 54.

A first wireless base station 57 is connected to one end of the first leaky transmission line 55, and a terminator 58 is connected to the other end. Further, a second wireless base station 59 is connected to one end of the second leaky transmission line 56, and a terminator 60 is connected to the other end.

The first wireless base station 57 communicates with a wireless communication terminal 61 on the desk 52 in the first wireless communication segment 53 via the first leaky transmission line 55. The second wireless base station 59 communicates with a wireless communication terminal 62 on the desk 52 in the second wireless communication segment 54 via the second leaky transmission line 56.

In a wireless communication system having such a configuration, a distance between the first leaky transmission line 55 and the second leaky transmission line 56 is in the same idea as that in the first embodiment described above. More specifically, with respect to a desired wireless link speed, a distance between the first leaky transmission line 55 and the second leaky transmission line 56 is set to a distance which is not more than twice as long as a maximum distance at which it is possible for the wireless communication terminal 61 (62) and the wireless base station 57 (59) to establish a wireless link to each other at the wireless link speed, and at which the two wireless base stations 57 and 59 cannot sense each other's carrier.

As a consequence, the first wireless base station 57 and the second wireless base station 59 can use the same wireless channel simultaneously.

Next, a concrete layout example of the two leaky transmission lines 55 and 56 will be described.

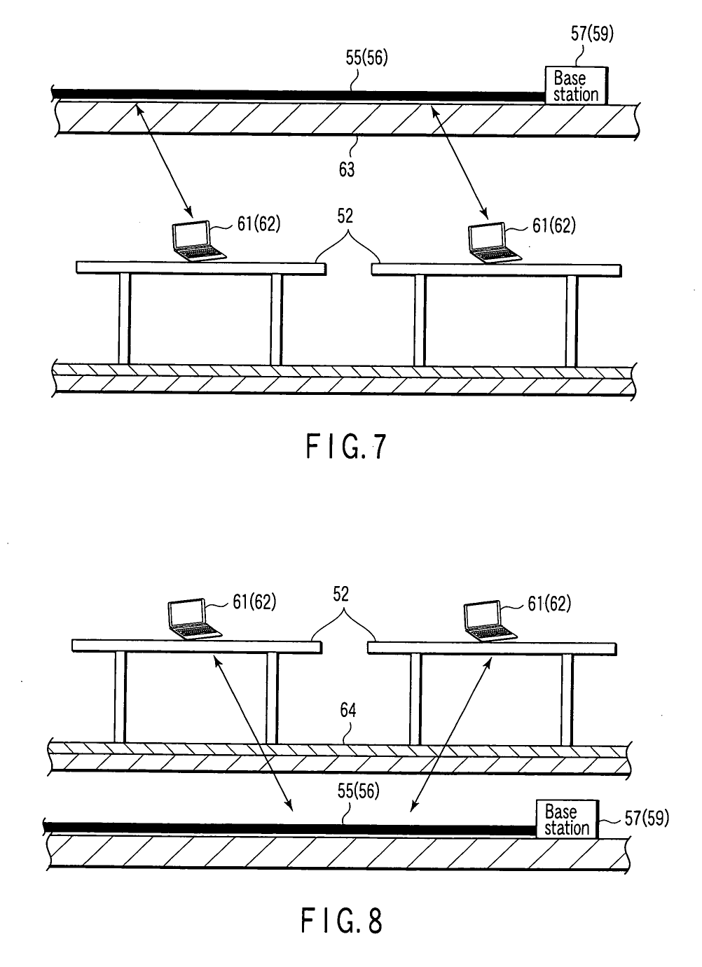

FIG. 7 shows one example. The leaky transmission line 55 (56) is laid behind a ceiling 63 so as to be located at the central portion of the wireless communication segment 53 (54). Then, the base station 57 (59) communicates with the wireless communication terminal 61 (62) on the desk 52 via the leaky transmission line 55 (56).

FIG. 8 shows another example. The leaky transmission line 55 (56) is laid beneath a floor 64 so as to be located at the central portion of the wireless communication segment 53 (54). Then, the base station 57 (59) communicates with the wireless communication terminal 61 (62) on the desk 52 via the leaky transmission line 55 (56).

In this way, the leaky transmission line 55 (56) is not exposed to the office by being laid behind the ceiling or beneath the floor.

### FOURTH EMBODIMENT

Another layout for leaky transmission lines will be described as a fourth embodiment of the invention. The layout can be applied to the respective embodiments described above.

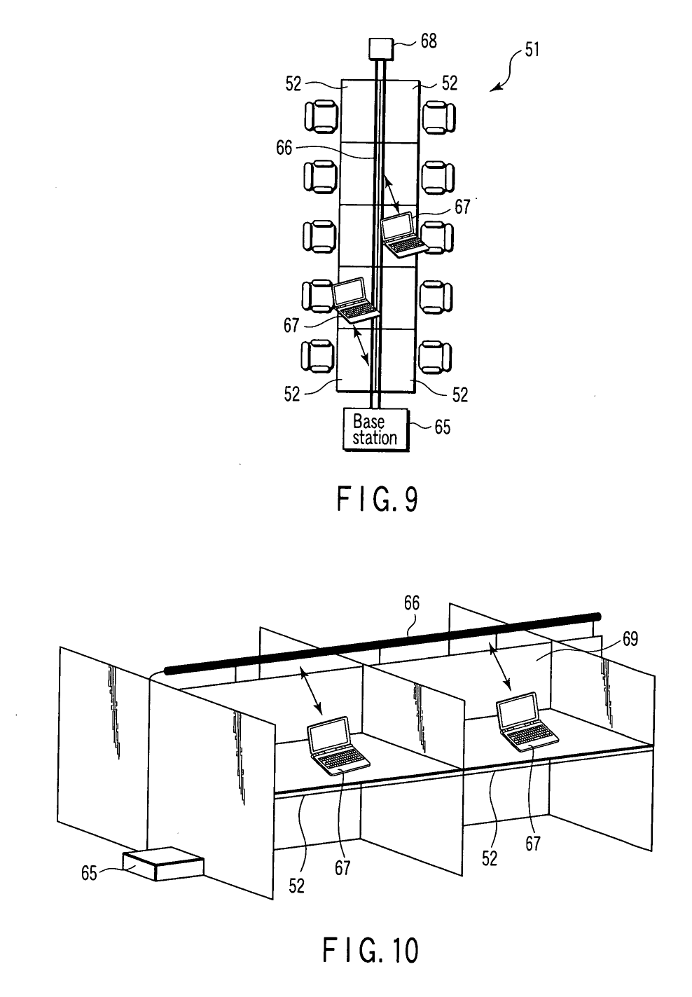

As shown in FIG. 9, the desks 52 are arranged face-to-face in two rows on the floor 51 in the office.

In such a layout, a leaky transmission line 66 connected to a wireless base station 65 is laid the central portion between the rows of the desks along the longitudinal direction of the rows of the desks. Or, the leaky transmission line 66 is laid in a direction perpendicular to the central portion between the rows of the desks, and at a position where it is possible for the wireless base station 65 to establish a wireless link to wireless communication terminals 67 placed on the desks. A terminator 68 is connected to an end of the leaky transmission line 66.

When in a wireless communication system having such a configuration, a plurality of leaky transmission lines 66 are laid, for example, two leaky transmission lines 66 are laid parallel to each other, a distance between the leaky transmission lines is set to be in the same idea as that in the first embodiment described above.

More specifically, assume that two sets of the wireless communication systems with the configuration of FIG. 9 are arranged. In this case, with respect to a desired wireless link speed, a distance between the two leaky transmission lines 66 is set to a distance which is not more than twice as long as a maximum distance at which the wireless communication terminals 67 and the wireless base stations 65 can establish wireless links to each other at the wireless link speed, and at which the two leaky transmission lines 66 are cannot sense each other's carrier.

As a consequence, the wireless base stations 65 connected to the leaky transmission lines 66 can use a same wireless channel simultaneously.

Next, a concrete layout example of the leaky transmission line 66 will be described.

FIG. 10 shows one example. The leaky transmission line 66 is laid above a partition 69 at the central portion between the rows of the desks 52 aligned in two rows. Then, the base station 65 communicates with the wireless communication terminals 67 via the leaky transmission line 66.

FIG. 11 shows another example. The leaky transmission line 66 is laid in a groove portion 70, such as an electric wiring duct, which is provided at the central portion between the rows of the desks 52 aligned in two rows. Then, the base station 65 communicates with the wireless communication terminals 67 via the leaky transmission line 66.

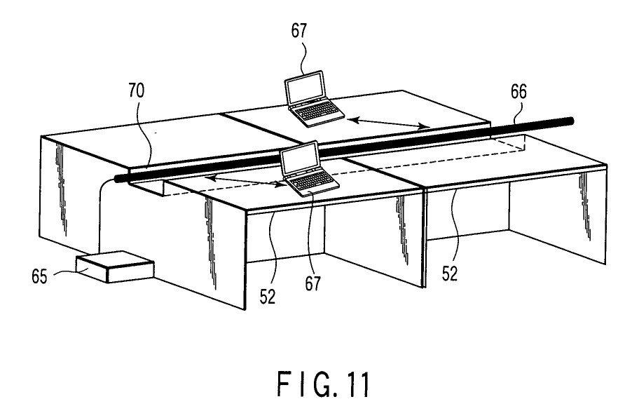

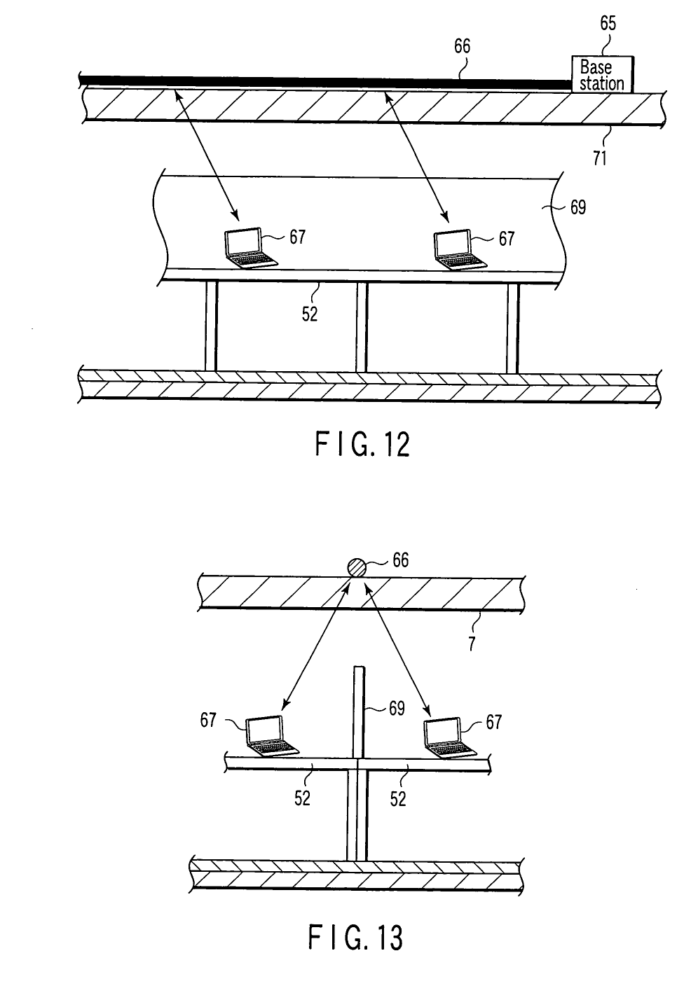

FIGS. 12 and 13 show another example. The leaky transmission line 66 is laid behind the ceiling 71 located right above the partition 69 at the central portion between the rows of the desks 52 aligned in two rows, and parallel to the rows of the desks 52. Then, the base station 65 communicates with the wireless communication terminals 67 via the leaky transmission line 66. In this way, the leaky transmission line 66 is not exposed to the office by being laid behind the ceiling.

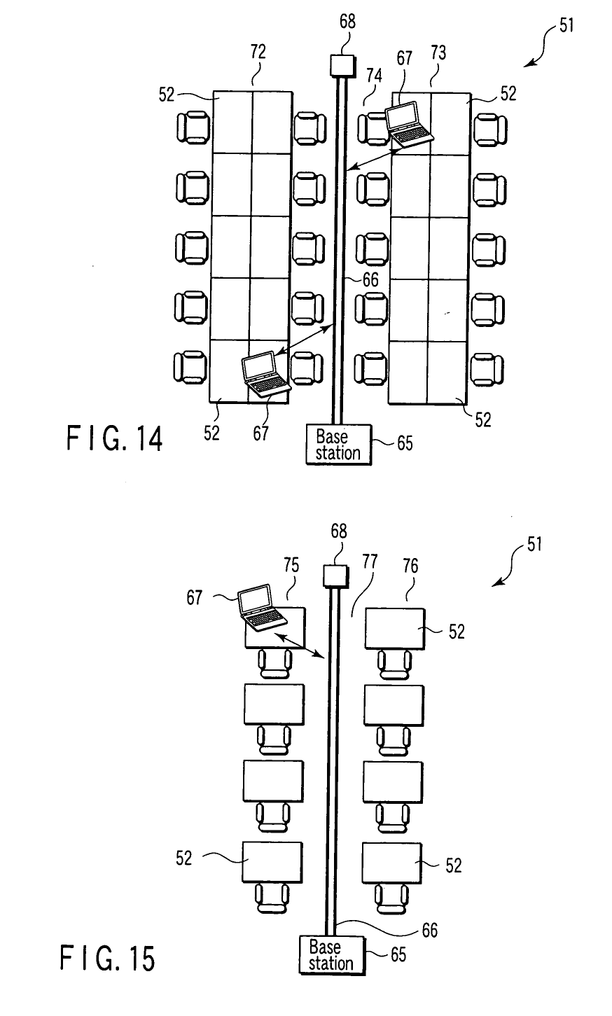

FIG. 14 shows yet another example. On the floor 51 in the office, a desk row 72 in which the desks 52 are aligned face-to-face in two rows, and a desk row 73 in which the desks 52 are aligned face-to-face in two rows are provided, which forms an aisle 74 between the desk rows 72 and 73.

In such a layout, the leaky transmission line 66 is laid in a direction perpendicular to the aisle 74 along the aisle 74, at a position at which it is possible for the wireless base station 65 to establish wireless links to the wireless communication terminals 67 placed on the desks.

FIG. 15 shows yet another example. On the floor 51 in the office, an aisle 77 is formed between a desk row 75 in which the desks 52 are aligned in one row vertically, and a desk row 76 in which the desks 52 are aligned in one row vertically.

In such a layout, the leaky transmission line 66 is laid in a direction perpendicular to the aisle 77 along the aisle 77, at a position at which it is possible for the wireless base station 65 to establish wireless links to the wireless communication terminals 67 placed on the desks.

When, in a wireless communication system having the configuration shown in FIG. 15, a plurality of leaky transmission lines 66 are laid, for example, two leaky transmission lines 66 are laid parallel to each other, a distance between the leaky transmission lines is set to be in the same idea as that in the first embodiment described above. More specifically, in the same way as the case of FIG. 9 described above, with respect to a desired wireless link speed, a distance between the two leaky transmission lines 66 is set to a distance which is not more than twice as long as a maximum distance at which the wireless communication terminals 67 and the wireless base stations 65 can establish wireless links to each other at the wireless link speed, and at which the two wireless base stations 65 cannot sense each other's carrier.

Next, a concrete layout example of the leaky transmission line 66 will be described.

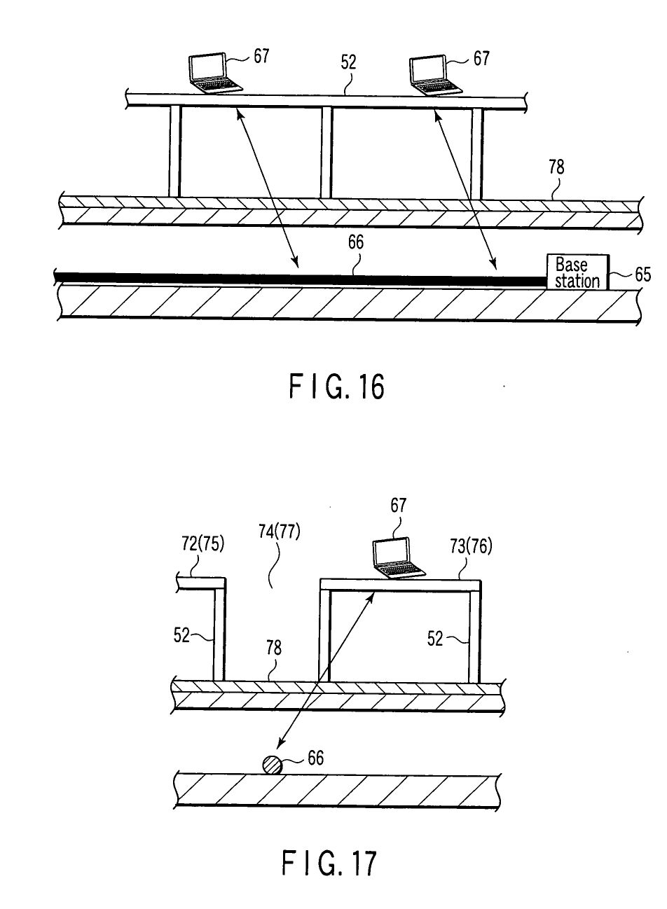

As shown in FIGS. 16 and 17, the leaky transmission line 66 is laid parallel to the rows of the desks beneath a floor 78 of the aisle 74 (77) provided between the desk row 72 (75) and the desk row 73 (76). Then, the base station 65 communicates with the wireless communication terminals 67 on the desks 52 via the leaky transmission line 66.

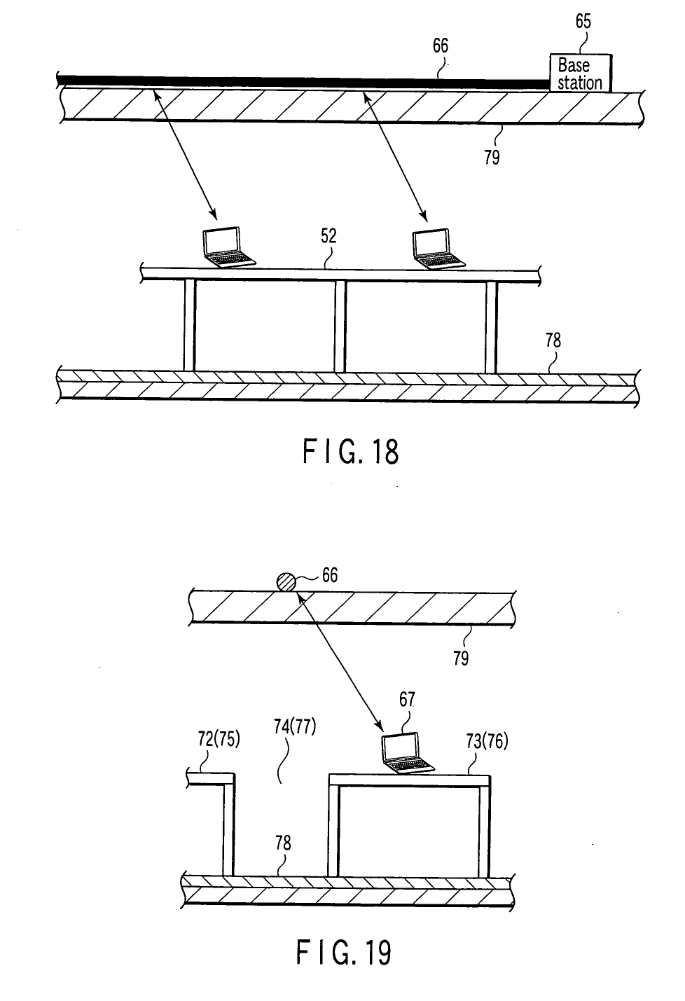

Further, as shown in FIGS. 18 and 19, the leaky transmission line 66 is laid behind a ceiling 79 located right above the aisle 74 (77) provided between the desk row 72 (75) and the desk row 73 (76), and parallel to the rows of the desks 52. Then, the base station 65 communicates with the wireless communication terminals 67 via the leaky transmission line 66.

In this way, the leaky transmission line 66 is not exposed to the office by being laid behind the ceiling or beneath the floor.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless communication system comprising:
a plurality of leaky transmission lines which are used as antennas; and
a plurality of wireless base stations which are respectively connected to the leaky transmission lines, and which communicates with corresponding wireless communication terminals via the connected leaky transmission lines, wherein
the leaky transmission lines are laid parallel to one another at intervals, and
two adjacent leaky transmission lines among the leaky transmission lines are laid at an interval of a distance at which it is impossible for the wireless base stations respectively connected to the leaky transmission lines to sense each other's carrier while using the same wireless channel, and of a distance not more than twice as long as a maximum distance between the leaky transmission line and the wireless communication terminal when the wireless base stations can establish wireless links to corresponding wireless communication terminals via the connected leaky transmission lines.

2. The wireless communication system according to claim 1, wherein
a plurality of wireless communication segments are arranged in advance, and the leaky transmission lines of the respective wireless base stations are laid at positions at which it is possible for the wireless base stations to establish wireless links to wireless communication terminals in the wireless communication segments in accordance with a layout of the wireless communication segments.

3. The wireless communication system according to claim 1, wherein
the leaky transmission lines of the wireless base stations are respectively laid at central portions between rows of desks aligned face-to-face in two rows, or at positions in a direction perpendicular to the rows of desks at which it is possible for the wireless base stations to establish wireless links to wireless communication terminals placed on the desks, and are laid along a longitudinal direction of the rows of desks.

4. The wireless communication system according to claim 1, wherein
the leaky transmission lines of the wireless base stations are respectively laid along aisles formed between rows of desks aligned at predetermined intervals, at positions in a direction perpendicular to the aisles at which it is possible for the wireless base stations to establish wireless links to wireless communication terminals placed on the desks.

5. A wireless communication system comprising:
a plurality of leaky transmission lines which are used as antennas; and
a plurality of wireless base stations which are respectively connected to the leaky transmission lines, and which communicate with corresponding wireless communication terminals via the connected leaky transmission lines, wherein
the leaky transmission lines are laid parallel to one another at intervals, and
among the leaky transmission lines, leaky transmission lines connected to wireless base stations using a same wireless channel, between which another n leaky transmission lines, which are connected to wireless base stations using wireless channels different from the wireless channel used by the two wireless base stations and different from one another, are laid, are laid at an interval of a distance at which it is impossible for the wireless base stations respectively connected to the leaky transmission lines to sense each other's carrier while using a same wireless channel, and of a distance not more than 2×(n+1) times as long as a maximum distance between the leaky transmission lines and the wireless communication terminals when the wireless base stations can establish wireless links to corresponding wireless communication terminals via the connected leaky transmission lines.

6. The wireless communication system according to claim 5, wherein
a plurality of wireless communication segments are arranged in advance, and the leaky transmission lines of the respective wireless base stations are laid at positions at which it is possible for the wireless base stations to establish wireless links to wireless communication terminals in the wireless communication segments in accordance with a layout of the wireless communication segments.

7. The wireless communication system according to claim 5, wherein
the leaky transmission lines of the wireless base stations are respectively laid at central portions between rows of desks aligned face-to-face in two rows, or at positions in a direction perpendicular to the rows of desks at which it is possible for the wireless base stations to establish wireless links to wireless communication terminals placed on the desks, leaky transmission lines are laid along a longitudinal direction of the rows of desks.

8. The wireless communication system according to claim 5, wherein
the leaky transmission lines of the wireless base stations are respectively laid along aisles formed between rows of desks arranged at predetermined intervals, at positions in-a direction perpendicular to the aisles at which it is possible for the wireless base stations to establish wireless links to wireless communication terminals placed on the desks.

9. A wireless communication system comprising:
a plurality of leaky transmission lines which are used as antennas;
a plurality of wireless base stations which are respectively connected to the leaky transmission lines, and which communicate with corresponding wireless communication terminals via the connected leaky transmission lines; and
a plurality of transmission electric power adjusting means for individually controlling transmission electric power supplied to the leaky transmission lines, wherein
the leaky transmission lines are laid parallel to one another at intervals, and
transmission electric power supplied to corresponding leaky transmission lines by the respective transmission electric power adjusting means is controlled to be less than transmission electric power which enables two wireless base stations connected to the leaky transmission lines to sense each other's carrier while using the same wireless channel, and to be transmission electric power which enables the wireless base station to establish wireless links to the wireless communication terminals at positions at a distance not less than half of a distance from the leaky transmission lines connected to the wireless base stations to adjacent leaky transmission lines.

10. A wireless communication system comprising:
a plurality of leaky transmission lines which are used as antennas;
a plurality of wireless base stations which are respectively connected to the leaky transmission lines, and which communicate with corresponding wireless communication terminals via the connected leaky transmission lines; and
a plurality of transmission electric power adjusting means for individually controlling transmission electric power supplied to the leaky transmission lines, wherein
the leaky transmission lines are laid parallel to one another at intervals,
among the leaky transmission lines, leaky transmission lines connected to wireless base stations using a same wireless channel, between which another n leaky transmission lines, which are connected to wireless base stations using wireless channels different from the wireless channel used by the two wireless base stations and different from one another, are laid, and
transmission electric power supplied to the leaky transmission lines connected to the wireless base stations using the same wireless channel by the transmission electric power adjusting means is controlled to be less than transmission electric power which enables the two wireless base stations using the same wireless channel to sense each other's carrier, and to be transmission electric power which enables the wireless base stations using the same wireless channel to establish wireless links to the wireless communication terminals at positions at a distance not less than half of a distance from the leaky transmission lines connected to the wireless base stations to adjacent leaky transmission lines.
